(19) United States
(12) Patent Application Publication
(10) Pub. No.: US 2008/0125142 A1
(43) Pub. Date: May 29, 2008

(54) MOBILE APPARATUS AND METHOD FOR DOWNLOADING OF MAP

(76) Inventor: Lee Chang-Hung, Dounan Township (TW)

Correspondence Address: HOFFMAN WARNICK & D'ALESSANDRO, LLC, 75 STATE STREET, 14TH FLOOR, ALBANY, NY, 12207, US

(21) Appl. No.: 11/944,502

(22) Filed: Nov. 23, 2007

(30) Foreign Application Priority Data
Nov. 24, 2006 (TW) 095143614

(51) Int. Cl. H04Q 7/20; G08G 1/123

(52) U.S. Cl. 455/456.6; 340/995.12

(57) ABSTRACT

The invention provides a method for downloading of maps for a mobile apparatus connected to a map server. Furthermore, the method of the invention includes four major steps. First of all, determine a present location of the mobile apparatus. Subsequently, determine a pre-set distance. Then, determine a first map information and a second map information according to the pre-set distance. Particularly, the first map information completely corresponds to map information with a coverage centered at the present location and with a radius of the pre-set distance, whereas the second map information corresponds to map information outside the coverage centered at the present location. Finally, download a map data which includes at least the first map information. By the method of the invention, user can selectively download maps in accordance with the needs of the user and the system environment.

### BACKGROUND OF THE INVENTION

1. Field of the Invention

The present invention relates generally to a mobile apparatus and method for downloading of a map.

2. Description of the Prior Art

Nowadays, mobile apparatus, such as mobile phone or PDA, can be installed with GPS system or communicated with a GPS system, so as to provide map download or navigation function to users. For example, U.S. Pat. No. 5,786,789 discloses GPS and cellphone unit having add-on modules.

Particularly, when a user drives a vehicle, such navigation function can provide the direction, the path, the environment and other information of a destination, to help the user to arrive the destination as soon as possible.

Furthermore, the navigation system applied in vehicles can be mainly classified to on-board navigation system, which stores a map data in a memory of the system or a storage media, such as an optical disk or a memory card; and off-board navigation system, which stores a map data in a map server, and wirelessly downloads the map data from the map server. Said navigation systems have been well disclosed in such as U.S. Pat. No. 6,381,535, U.S. Pat. No. 6,526,284, and U.S. Pat. No. 6,462,676.

However, with the increase of sophistication and amount of data, the on-board navigation system needs memory or storage media with large capacity to support map data of different areas for the user. Therefore, that increases the cost for producing said system and causes inconvenient for using the system.

Similarly, the off-board navigation system also needs a memory with large capacity to store downloaded map data. Moreover, when the connecting speed between the navigation system and the map server is too slow, the update of map data may be too late, so that the navigation function could be effected.

### SUMMARY OF THE INVENTION

Accordingly, one aspect of the present invention is to provide a mobile apparatus and method for downloading of a map to solve the above-mentioned problems.

According to the first preferred embodiment of the invention, the method for downloading a map by a mobile apparatus connected to a map server includes the following steps of:

First of all, determines a present location of the mobile apparatus, and then determines a pre-set distance. Afterward, determines a first map information and a second map information according to the pre-set distance. Particularly, the first map information completely corresponds to map information located in a coverage between the present location and the pre-set distance, the first map information is centered at the present location and with a radius of the pre-set distance, and the second map information corresponds to map information outside the coverage. Finally, downloads a map data which includes at least the first map information.

According to the second preferred embodiment of the invention, the method for downloading a map by a mobile apparatus connected to a map server includes the following steps of:

First of all, determines a present location of the mobile apparatus, and then determines a system parameter of the mobile apparatus and transmits the system parameter to the map server. Afterward, receives a map data downloaded from the map server. Particularly, a cover distance and a map resolution of the map data are capable of being selectively changed in accordance with the system parameter. Finally, stores the map data.

Additionally, in the preferred embodiment, the cover distance corresponds to the distance of the present location, and the map resolution is the amount of the map data.

According to the third preferred embodiment of the invention, the mobile apparatus, connected to a map server, includes a memory, a positioning module, a communication module, and a processing module.

Furthermore, the positioning module is applied for determining a present location. The communication module is used for receiving a map data from the map server, and the map data includes a first map information and a second map information. The processing module is applied for setting a pre-set distance and for storing at least the first map information in the memory.

In the preferred embodiment, the first map information completely corresponds to map information with a coverage centered at the present location and with a radius of the pre-set distance, and the second map information corresponds to map information outside the coverage.

According to the fourth preferred embodiment of the invention, the mobile apparatus, connected to a map server, includes a positioning module, a determining module, a communication module, and a memory.

Furthermore, the positioning module is used for determining a present location, whereas the determining module is used for determining a system parameter. The communication module is applied for transmitting the system parameter to the map server and for receiving a map data from the map server. Moreover, the memory is used for storing the map data.

In the preferred embodiment, the map server selectively adjusts a cover distance and a map resolution of the map data in accordance with the system parameter. Particularly, the cover distance corresponds to the distance of the present location, and the map resolution is the amount of the map data.

The objective of the present invention will no doubt become obvious to those of ordinary skill in the art after reading the following detailed description of the preferred embodiment, which is illustrated in the various figures and drawings.

### BRIEF DESCRIPTION OF THE APPENDED DRAWINGS

FIG. 1A shows a flow chart of a method for downloading a map of a preferred embodiment of the invention.

FIG. 1B shows a map downloaded by the method as shown in FIG. 1A.

FIG. 2A shows a flow chart of a method for downloading a map of an embodiment of the invention.

FIG. 2B shows a map downloaded by the method as shown in FIG. 2A.

FIG. 3A shows a flow chart of a method for downloading a map of an embodiment of the invention.

FIG. 3B shows a map downloaded by the method as shown in FIG. 3A.

FIG. 4A shows a flow chart of a method for downloading a map of a preferred embodiment of the invention.

FIG. 4B shows a flow chart of a method for downloading a map of an embodiment of the invention.

FIG. 4C shows a flow chart of a method for downloading a map of an embodiment of the invention.

FIG. 4D shows a flow chart of a method for downloading a map of an embodiment of the invention.

FIG. 5 shows a functional block of a mobile apparatus of an embodiment of the invention.

### DETAILED DESCRIPTION OF THE INVENTION

The invention provides a mobile apparatus and method for downloading a map. The preferred embodiment according to the present invention is disclosed as follow.

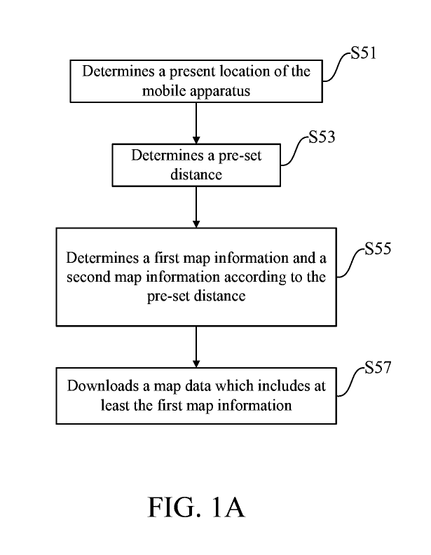

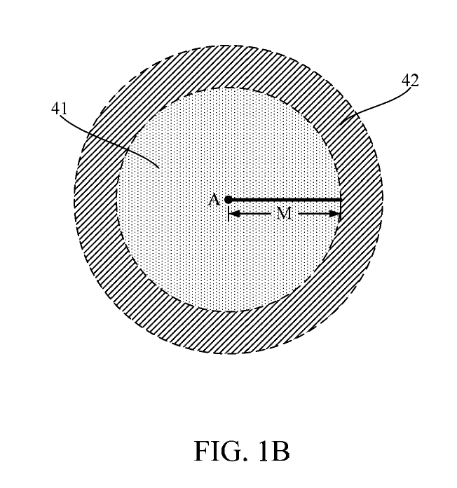

Please refer to FIG. 1A and FIG. 1B. FIG. 1A shows a flow chart of a method for downloading a map of a preferred embodiment of the invention; and FIG. 1B shows a map downloaded by the method as shown in FIG. 1A. In the preferred embodiment, the method is suitable for a mobile apparatus which connects to a map server. Moreover, the connection between the mobile apparatus and the map server can be a wired connection or wireless connection. The method of the invention includes the steps of:

Step S51, determines a present location A of the mobile apparatus. In practice, the present location A can be determined by a Global Positioning System (GPS) or positioned by the three neighborhood base stations. Practically, lots of methods have been disclosed in other prior arts to determine the position of mobile apparatus and will not be discussed herein.

Step S53, determines a pre-set distance M. In practice, the pre-set distance M can be set by the mobile apparatus, and the pre-set distance M can be sent to the map server. On the other hand, the pre-set distance can be set by the map server by a user via phone, fax, internet, or other human-machine interface.

Step S55, determines a first map information 41 and a second map information 42 according to the pre-set distance M. Moreover, the first map information 41 completely corresponds to map information with a coverage centered at the present location A and with a radius of the pre-set distance M, and the second map information 42 corresponds to map information outside the coverage centered at the present location A and with a radius of the pre-set distance M.

Step S57, downloads a map data which includes at least the first map information 41 which corresponds to map information with a coverage centered at the present location A and with a radius of the pre-set distance M. Practically, users may be more interested in the first map information 41 because of navigation or finding an address. Therefore, the map data includes at least the first map information 41. After the transmission of the first map information 41, the map data can further includes the second map information 42.

In practice, the first resolution of the first map information is higher than the second resolution of the second map information. For example, the first resolution can include major roads and secondary roads, whereas the second resolution may only include major roads. The invention considers that the user may need more map information, such as the information contains major roads, secondary roads, house numbers, stores, and place names, within distance M, and need less map information, such as the information only contains major roads and secondary roads, outside of the distance M.

In an embodiment, when the downloaded map data includes the second map information 42, the method of the invention further determines a present speed of the mobile apparatus, and the amount of the second map information 42 increases progressively in accordance with the present speed. That is to say, when the present speed of the mobile apparatus is higher, the user has more opportunity to exceed the distance M, therefore, the user may need the second map information 42 with larger covering range, and that increases the amount of the second map information 42. For example, assume the distance M as 500 m, if the user is walking (present speed is less than 4 km/hr) or static, 1000 m could be enough for the covering range of the second map information 42, however, if the user is driving (present speed is larger than 60 km/hr), the covering range of the second map information 42 may be increased to 2000 m, and the second map information 42 can include the information from 500 m to 2000 m away from the user.

In an embodiment, when the map data includes the second map information 42, the method of the invention further determines a connecting speed between the mobile apparatus and the map server, and the amount of the second map information increases progressively in accordance with the connecting speed. For example, when the connecting speed is 100 kbps, the second map information 42 only contains major roads, however, when the connecting speed increased to 300 kbps, the second map information 42 can further contain names of regions and scenic spots. For another example, when the connecting speed is 100 kbps, the second map information 42 contains information from 500 m to 1000 m away from the mobile apparatus, whereas when the connecting speed in 300 kbps, the second map information 42 contains information from 500 m to 3000 m away from the mobile apparatus.

In an embodiment, when the map data includes the second map information 42, the method of the invention further determines a capacity of a memory of the mobile apparatus, and the amount of the second map information 42 increases progressively in accordance with the capacity. That is, the larger the capacity of the memory, the larger the amount of the second map information 42.

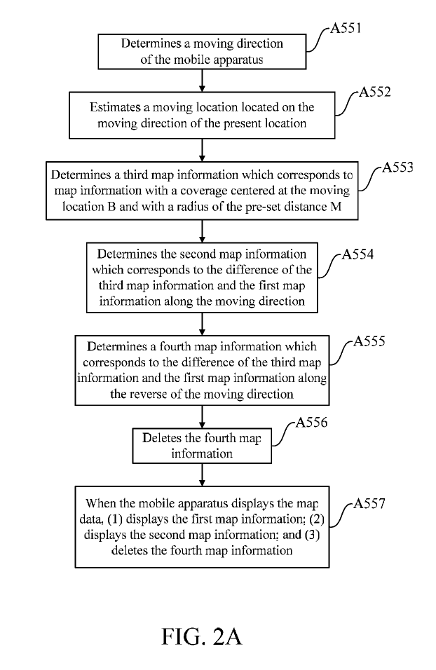

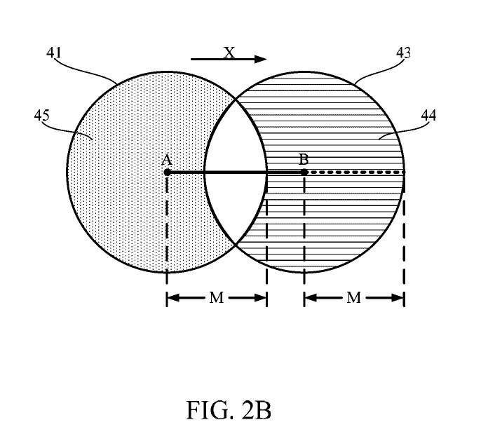

Please refer to FIG. 2A and FIG. 2B. FIG. 2A shows another method for determining the first map information 41 and the second map information 42 within step S55 of FIG. 1A; and FIG. 2B shows a map downloaded by the method in FIG. 2A. In the embodiment, the mobile apparatus is located at the present location A, and a pre-set distance M is determined. Furthermore, the method for determining the second map information 44 of step S55 in FIG. 1A can further includes the following steps:

Step A551, determines a moving direction X of the mobile apparatus. Practically, the moving direction X can be calculated by detecting the change of coordinates of the mobile apparatus during a period of time.

Step A552, estimates a moving location B located along the moving direction X of the present location A. Practically, the moving location B can be a pre-determined location or be determined in accordance with the moving speed of the mobile apparatus.

Step A553, determines a third map information 43 which corresponds to map information centered at the moving location B and with a radius of the pre-set distance M.

Step A554, determines the second map information 44 which corresponds to the difference of the third map information 43 and the first map information 41 along the moving direction X. Accordingly, the difference means the map information, which is not contained in the first information 41, contained in the third map information 43 along the moving direction X.

The above-mentioned steps A551 to A554 refer to the method for determining the first map information 41 and the second map information 42 of step S55 in FIG. 1A. Furthermore, when the mobile apparatus displays the map data, the method of the invention further includes the following step A555 and A556.

Step A555, determines a fourth map information 45 which corresponds to the difference of the third map information 43 and the first map information 41 along the inverse of the moving direction X. Accordingly, the difference means the map information, which is not contained in the third information 43, contained in the first map information 41 along the inverse of the moving direction X.

Step A556, deletes the fourth map information 45.

Step A557, when the mobile apparatus displays the map data, the method of the invention further (1) displays the first map information 41; (2) displays the second map information 44; and (3) deletes the fourth map information 45; wherein the step (2) and (3) can be exchanged.

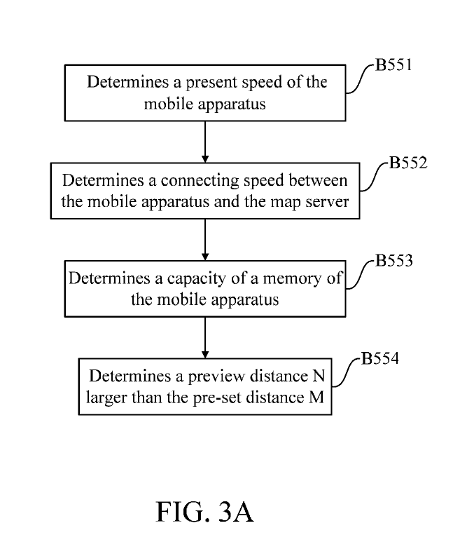

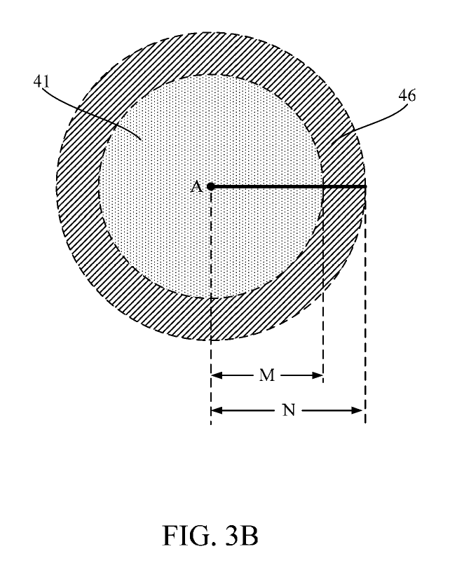

Please refer to FIG. 3A and FIG. 3B. FIG. 3A shows a flow chart of a method for determining the first map information 41 and the second map information 46 of step 55 in FIG. 1A; and FIG. 3B shows a map downloaded by the method as shown in FIG. 3A. In the embodiment, the mobile apparatus is located at the present location A, and a pre-set distance M is determined. Furthermore, the method of step S55 in FIG. 1A can further includes the following steps:

Step B551, determines a present speed of the mobile apparatus.

Step B552, determines a connecting speed between the mobile apparatus and the map server.

Step B553, determines a capacity of a memory of the mobile apparatus.

Step B554, determines a preview distance N larger than the pre-set distance M, and the second map information 46 corresponds to map information with a coverage centered at the present location A and with a radius of the preview distance N. Furthermore, the preview distance N can be a pre-set value or be adjusted in accordance with the above-mentioned connecting speed, capacity of memory, or current speed of the mobile apparatus.

For example, when the connecting speed is higher; the capacity of memory is larger; or the current speed of the mobile apparatus is higher, the preview distance N can be optionally increased to reach an optimal adjustment.

When the above-mentioned first map information has a first resolution and second map information has a second resolution which is smaller than the first resolution, the second resolution can be increased progressively, and the preview distance is a fixed value, the second resolution can be increased progressively based on the connecting speed mentioned in step B552 or the capacity of memory mentioned in step B553. On the contrary, the second resolution can be decreased progressively based on the current speed mentioned in step B551.

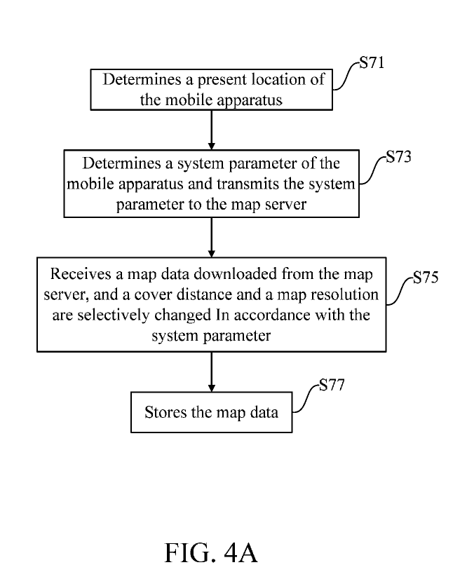

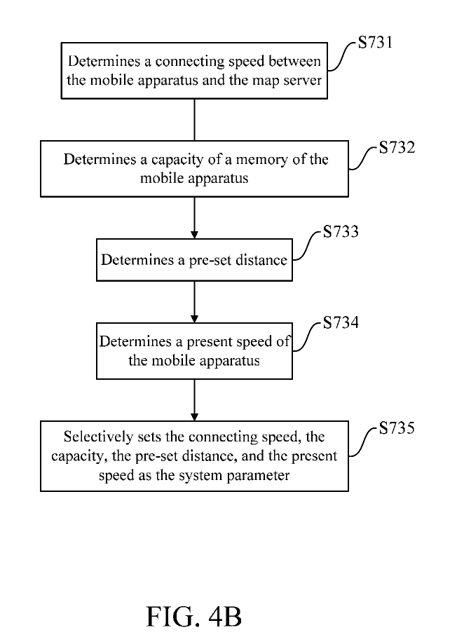

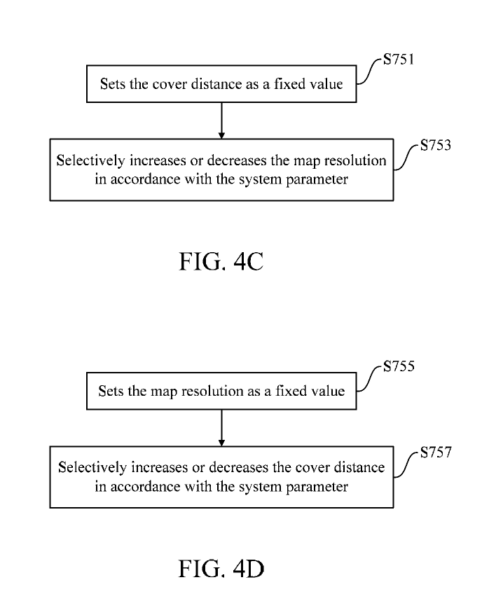

Please refer to FIG. 4A which shows a flow chart of a method for downloading a map of a preferred embodiment of the invention. In the preferred embodiment, the method of the invention is suitably applied in a mobile apparatus connected to a map server. As shown in FIG. 4A, the method includes the following steps:

Step S71, determines a present location of the mobile apparatus.

Step S73, determines a system parameter of the mobile apparatus and transmits the system parameter to the map server. In practice, the system parameter can include one or more parameters and be transmitted to the map server at once. Moreover, the system parameter can be, but not limited to, such as the connecting speed between the mobile apparatus and the map server; the capacity of memory of the mobile apparatus; the present speed of the mobile apparatus; or the pre-set distance inputted by the mobile apparatus.

Step S75, receives a map data downloaded from the map server. Furthermore, a cover distance and a map resolution of the map data can be selectively changed in accordance with the system parameter.

Step S77, stores the map data. Particularly, the cover distance of the map data corresponds to the distance of the present location, and the map resolution is the amount of the map data.

Please further refer to FIG. 4B, which shows a flow chart of a method for downloading a map of an embodiment of the invention. In the embodiment, step S73 in FIG. 4A further includes the following steps:

Step S731, determines a connecting speed between the mobile apparatus and the map server.

Step S732, determines a capacity of a memory of the mobile apparatus.

Step S733, determines a pre-set distance.

Step S734, determines a present speed of the mobile apparatus.

Step S735, selectively sets the connecting speed, the capacity, the pre-set distance, and the present speed as the system parameter.

Please further refer to FIG. 4C, which shows a flow chart of a method for downloading a map of an embodiment of the invention. In the embodiment, step S75 in FIG. 4A further includes the following steps:

Step S751, sets the cover distance as a fixed value.

Step S753, selectively increases or decreases the map resolution in accordance with the system parameter. For example, assume that the system parameters include the connecting speed and the capacity of memory, when the connecting speed is higher and the capacity of memory is larger, the resolution can be selectively increased.

Please further refer to FIG. 4D, which shows a flow chart of a method for downloading a map of an embodiment of the invention. In the embodiment, step S75 in FIG. 4A further includes the following steps:

Step S755, sets the map resolution as a fixed value.

Step S757, selectively increases or decreases the cover distance in accordance with the system parameter. For example, assume that the system parameters include the connecting speed and the capacity of memory, when the connecting speed is higher and the capacity of memory is larger, the cover distance can be selectively increased.

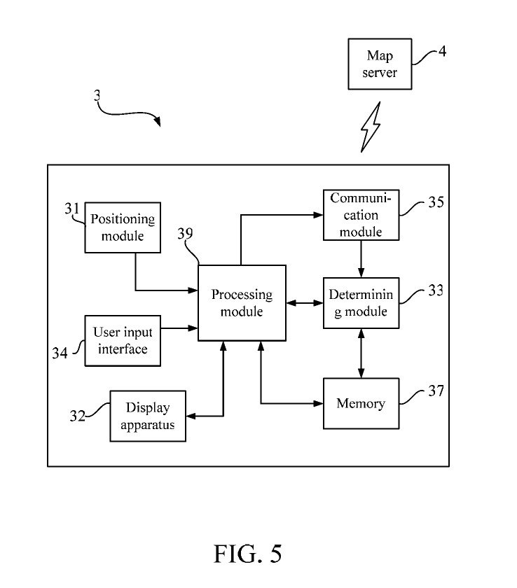

Please refer to FIG. 5, which shows a functional block of a mobile apparatus of an embodiment of the invention. As shown in FIG. 5, the mobile apparatus 3 of the embodiment is wirelessly connected to a map server 4. Furthermore, the mobile apparatus 3 includes a positioning module 31, a display apparatus 32, a determining module 33, a user input interface 34, a communication module 35, a memory 37, and a processing module 39.

Furthermore, the positioning module 31, such as GPS, is used for determining a present location of the mobile apparatus 3. The determining module 33 is used for determining system parameters. The communication module 35 is applied for transmitting the system parameters and the present location to the map server 4, and for receiving a map data from the map server 4, and the map data can include a first map information and a second map information. The memory 37 is used for storing the map data. The display apparatus 32 is used for displaying the map data stored in the memory 37. The user input interface 34 can provide users to operate the mobile apparatus 3. Additionally, the processing module 39 is used for setting a pre-set distance, and for storing the pre-set distance in the memory 37.

Particularly, the first map information completely corresponds to map information with a coverage centered at the present location and with a radius of the pre-set distance, and the second map information corresponds to the map information outside the above-mentioned coverage.

Please note that, in the embodiment, the map server 4 selectively adjusts a cover distance and a map resolution of the map data according to the system parameters. Moreover, the cover distance corresponds to the present location, and the map resolution refers to the amount of information of the map data.

Furthermore, in practice, the positioning module 31 determines a first present location and a second present location during the beginning and the end of an unit time. The processing module 39 determines a moving direction of the mobile apparatus in accordance with the first present location, the second present location, and the unit time. Furthermore, the processing module 39 further estimates a moving location located along the moving direction of the present location. Moreover, the map server 4 determines a third map information which corresponds to map information with a coverage centered at the moving location and with a radius of the pre-set distance. The map server 4 further determines the second map information which corresponds to the difference of the third map information and the first map information along the moving direction. Furthermore, the processing module 39 can determine a fourth map information which corresponds to the difference of the third map information and the first map information along the inverse of the moving direction, and the processing module 39 can delete the fourth map information from the memory 37.

Furthermore, the positioning module 31 determines a first present location and a second present location during the beginning and the end of an unit time, and the processing module 39 determines a present speed of the mobile apparatus 3 in accordance with the first present location, the second present location, and the unit time. Moreover, the amount of the second map information increases progressively in accordance with the present speed. The determining module 33 further selectively sets the connecting speed, the capacity of the reserving block, the pre-set distance, and the present speed as the system parameter.

In practice, the communication module 35 and the map server 4 transmit the map data with a connecting speed, and the amount of the second map information increases progressively in accordance with the connecting speed. Furthermore, the memory 37 further includes a reserving block for storing the map data, and the amount of the second map information increases progressively in accordance with the capacity of the reserving block.

Practically, the processing module 39 can determine a preview distance which is larger than the pre-set distance, and the second map information further corresponds to map information with a coverage centered at the present location and with a radius of the preview distance.

Practically, the map server 4 can sets the cover distance as a fixed value, and selectively increases or decreases the map resolution in accordance with the system parameter. For instance, assume that the connecting speed and the capacity of reserving block are the system parameters, when the connecting speed is higher or the capacity of reserving block is larger, the map resolution can be selectively increased.

Practically, the map server 4 can sets the map resolution as a fixed value, and selectively increases or decreases the cover distance in accordance with the system parameter. For instance, assume that the connecting speed and the capacity of reserving block are the system parameters, when the connecting speed is higher or the capacity of reserving block is larger, the cover distance can be selectively increased.

In practice, the memory 37 can be a flash memory, a static random access memory (SRAM), a dynamic random access memory (DRAM), a synchronous dynamic random access memory (SDRAM), or a combination of the above-mentioned memory. Practically, a first resolution of the first map information is higher than a second resolution of the second map information. For instance, the first map resolution includes major roads and secondary roads, and the second resolution may only include major roads.

Obviously, the mobile apparatus and method for downloading a map can adjust the amount of map information by detecting and setting system parameters and the environment of the mobile apparatus. Accordingly, the mobile apparatus and method can reduce the use of memory, and further reduce the cost of producing, and also can help user to operate the mobile apparatus smoothly.

Although the present invention has been illustrated and described with reference to the preferred embodiment thereof, it should be understood that it is in no way limited to the details of such embodiment but is capable of numerous modifications within the scope of the appended claims.

What is claimed is:

1. A method for downloading a map by a mobile apparatus connected to a map server, the method comprising the following steps of:
(A) determining a present location of the mobile apparatus;
(B) determining a pre-set distance;
(C) determining a first map information and a second map information according to the pre-set distance, wherein the first map information completely corresponds to map information with a coverage centered at the present location and with a radius of the pre-set distance, and the second map information corresponds to map information outside the coverage centered at the present location; and
(D) downloading a map data comprising at least the first map information.

2. The method of claim 1, wherein the map data further comprises the second map information.

3. The method of claim 2, further comprising the following step of:
(B1) determining a present speed of the mobile apparatus;
wherein the amount of the second map information depends on the present speed.

4. The method of claim 2, wherein a first resolution of the first map information is higher than a second resolution of the second map information.

5. The method of claim 4, wherein the first resolution comprises major roads and secondary roads, and the second resolution comprises major roads.

6. The method of claim 2, further comprising the following step of:
(B2) determining a connecting speed between the mobile apparatus and the map server;
wherein the amount of the second map information depends on the connecting speed.

7. The method of claim 2, further comprising the following step of:
(B3) determining a capacity of a memory of the mobile apparatus;
wherein the amount of the second map information depends on the capacity.

8. The method of claim 2, further comprising the following steps of:
(D1) determining a moving direction of the mobile apparatus;
(D2) estimating a moving location located along the moving direction of the present location;
(D3) determining a third map information corresponding to map information centered at the moving location and with a radius of the pre-set distance; and
(D4) determining the second map information corresponding to the difference between the third map information and the first map information along the moving direction.

9. The method of claim 8, further comprising the following steps of:
(D5) determining a fourth map information corresponding to the difference between the third map information and the first map information along the inverse of the moving direction; and
(D6) deleting the fourth map information.

10. The method of claim 2, further comprising the following step of:
(B4) determining a preview distance larger than the pre-set distance;
wherein the second map information further corresponds to map information with a coverage centered at the present location and with a radius of the preview distance.

11. The method of claim 10, further comprising the following steps of:
(B5) determining a present speed of the mobile apparatus;
(B6) determining a connecting speed between the mobile apparatus and the map server; and
(B7) determining a capacity of a memory of the mobile apparatus;
wherein the preview distance is selectively adjusted in accordance with the connecting speed, the capacity, and the current speed.

12. A method for downloading a map by a mobile apparatus connected to a map server, the method comprising the following steps of:
(A) determining a present location of the mobile apparatus;
(B) determining a system parameter of the mobile apparatus and transmitting the system parameter to the map server;
(C) receiving a map data downloaded from the map server, and a cover distance and a map resolution of the map data being selectively changed in accordance with the system parameter; and
(D) storing the map data;
wherein the cover distance corresponds to the distance of the present location, and the map resolution is the amount of the map data.

13. The method of claim 12, further comprising the following steps of:
(C1) setting the cover distance as a fixed value; and
(C2) selectively increasing or decreasing the map resolution in accordance with the system parameter.

14. The method of claim 12, further comprising the following steps of:
(C3) setting the map resolution as a fixed value; and
(C4) selectively increasing or decreasing the cover distance in accordance with the system parameter.

15. A mobile apparatus connecting to a map server, the mobile apparatus comprising:
a memory;
a positioning module for determining a present location;
a communication module for receiving a map data from the map server, and the map data comprising a first map information and a second map information; and
a processing module for setting a pre-set distance and storing at least the first map information in the memory;
wherein the first map information completely corresponds to map information with a coverage centered at the present location and with a radius of the pre-set distance, and the second map information corresponds to map information outside the coverage.

16. The mobile apparatus of claim 15, wherein the positioning module determines a first present location and a second present location during the beginning and the end of an unit time, and the processing module determining a present speed in accordance with the first present location, the second present location, and the unit time, wherein the amount of the second map information depends on the present speed.

17. The mobile apparatus of claim 15, wherein a first resolution of the first map information is higher than a second resolution of the second map information.

18. The mobile apparatus of claim 15, wherein the communication module and the map server transmitting the map data with a connecting speed, and the amount of the second map information increasing progressively in accordance with the connecting speed.

19. The mobile apparatus of claim 15, wherein the positioning module determines a first present location and a second present location during the beginning and the end of an unit time, and the processing module determining a moving direction of the mobile apparatus in accordance with the first present location, the second present location, and the unit time, and the processing module estimating a moving location, and the map server determining a third map information which corresponds to map information with a coverage centered at the moving location and with a radius of the pre-set distance, and the map server determining the second map information corresponding to the difference of the third map information and the first map information along the moving direction.

20. The mobile apparatus of claim 19, wherein the processing module determines a fourth map information corresponding to the difference of the third map information and the first map information along the inverse of the moving direction, and the processing module deleting the fourth map information from the memory.

21. The mobile apparatus of claim 15, wherein the processing module determines a preview distance larger than the pre-set distance, and the second map information further corresponding to map information with a coverage centered at the present location and with a radius of the preview distance.

22. The mobile apparatus of claim 21, wherein a first resolution of the first map information is higher than a second resolution of the second map information.

23. A mobile apparatus connecting to a map server, the mobile apparatus comprising:
a positioning module for determining a present location;
a determining module for determining a system parameter;
a communication module for transmitting the system parameter to the map server and receiving a map data from the map server;
a memory for storing the map data; and
a processing module for setting a pre-set distance;
wherein the map server selectively adjusts a cover distance and a map resolution of the map data in accordance with the system parameter, the cover distance corresponding to the distance of the present location, and the map resolution is the amount of the map data.

24. The mobile apparatus of claim 23, wherein the map server sets the cover distance as a fixed value, and the map server selectively increasing or decreasing the map resolution in accordance with the system parameter.

25. The mobile apparatus of claim 23, wherein the map server sets the map resolution as a fixed value, and the map server selectively increasing or decreasing the cover distance in accordance with the system parameter.
